(19) United States
(12) Patent Application Publication
(10) Pub. No.: US 2008/0289975 A1
(43) Pub. Date: Nov. 27, 2008

(54) Spill Resistant Container and Toy

(75) Inventor: Jerry Sharber, Cypress, CA (US)

Correspondence Address: BANNER & WITCOFF, LTD., TEN SOUTH WACKER DRIVE, SUITE 3000, CHICAGO, IL, 60606, US

(73) Assignee: Imperial Toy, LLC, North Hills, CA (US)

(21) Appl. No.: 11/932,475

(22) Filed: Oct. 31, 2007

Related U.S. Application Data
(60) Provisional application No. 60/939,760, filed on May 23, 2007.

(51) Int. Cl. B65D 85/00; A63H 33/28; B65D 51/00; B29C 45/00

(52) U.S. Cl. 206/207; 446/15; 220/229; 264/238

(57) ABSTRACT

A spill resistant container assembly having a container adapted to contain a fluid, such as a bubble solution is provided. A generally elastic concave seal member extends across an opening of the container so as to aid in preventing the fluid from spilling out of the container, if the container is knocked over or held in an inverted position. The seal member has a slit capable of receiving the first end of a fluid carrier member such as a bubble wand. The elasticity of the seal member holds the slit in a normally closed position to prevent spilling.

This application claims priority to Provisional Application No. 60/939,760.

### BACKGROUND OF THE INVENTION

Children love making bubbles, and adults regularly buy large quantities of containers of bubble fluids and bubble wands for children. Typical bubble containers are small plastic cylinders with screw top lids. When used, their lids are off. When knocked over or not held upright, they often spill all of their contents. In the past, efforts have been made to create spill resistant containers. One such effort is represented by U.S. Pat. No. 5,304,085 issued Apr. 19, 1994 to Patricia Novak, and another is represented by U.S. Pat. No. Re. 36,131 issued Mar. 9, 1999. The former has a lid with a slot, and interleaved fingers in the slot. The latter has a low level of fluid accompanied by a funnel.

### SUMMARY OF THE INVENTION

One aspect of the invention relates spill resistant containers which can be used as a bubble container or a bubble toy. The spill resistant container may include a unique seal member, such as a spill resistant wand-entry member or a “fluid carrier”-entry member. The seal members include slits, capable of receiving ends of fluid-carrier members, such as bubble wands. The seal members may extend across openings in the containers. They aid in preventing fluid from leaking from the containers in a substantial variety of orientations of the containers. They may have sidewalls along the slits that contact each other in the absence of the fluid-carrier members, and that separate or allow the slits to open into slots resiliently to allow the fluid carrier member to enter and exit through the slits.

In one exemplary embodiment, the slits are smooth and have infinitesimal to zero space between the equally smooth sidewalls as the sidewalls are in a rest position and when no fluid-carrier members are present. Also, the slits open to be slots just as wide as the fluid carrier member thicknesses when the sidewalls are separated and the fluid-carrier members are passing through. Once the seal members are otherwise formed, such as by being molded, the slits can be cut by a sharp blade instrument for example, a guillotine. Additionally, a groove can be formed on each side of the seal members such that a slit can be formed in the seal member by tearing the material forming the groove.

In an exemplary embodiment, the seal members are also partially spherical, convex (curved away) bodies such as diaphragms, as viewed from the exteriors of the associated containers and toys. As the fluid-carrier members are pushed into the seal members, the seal members adjacent the slits are pushed and stretched toward greater width and radius, and act as diaphragms, opening the slits. As the fluid-carrier members are then pulled from the seal members, the slits are resiliently biased against the fluid-carrier members, and the sidewalls of the slits touch and wipe the fluid-carrier members of excess fluids, thereby returning the fluids into the bottle. The wiping action, therefore, has the advantage of reducing the dripping of excess fluid from the fluid-carrier members when they are removed from the containers and toys. The downward, inward concave shape of the seal member also has the advantage of collecting fluid not wiped and directing it back into the bottle through the slots when opened by reinserting the fluid carrier member.

### BRIEF DESCRIPTION OF THE DRAWINGS

FIG. 1 is a top-perspective view of the spill resistant container assembly.

FIG. 2 is a cross-sectional view through an embodiment of a seal member.

FIG. 3 is a bottom view of the lid assembly.

FIG. 4 is a partial-perspective view of a top portion of the spill resistant container assembly with a portion of the lid assembly cut away.

FIG. 5 is a perspective view of another embodiment of the spill resistant container assembly.

FIG. 6 is a perspective view of an exemplary embodiment of the fluid carrier member.

FIG. 7 is a perspective view of a first side of an exemplary embodiment of the fluid carrier member.

FIG. 7A is a cross-sectional view of an exemplary embodiment of a fluid carrier member.

FIG. 8 is a perspective view of a second side of an exemplary embodiment of the fluid carrier member.

### DETAILED DESCRIPTION

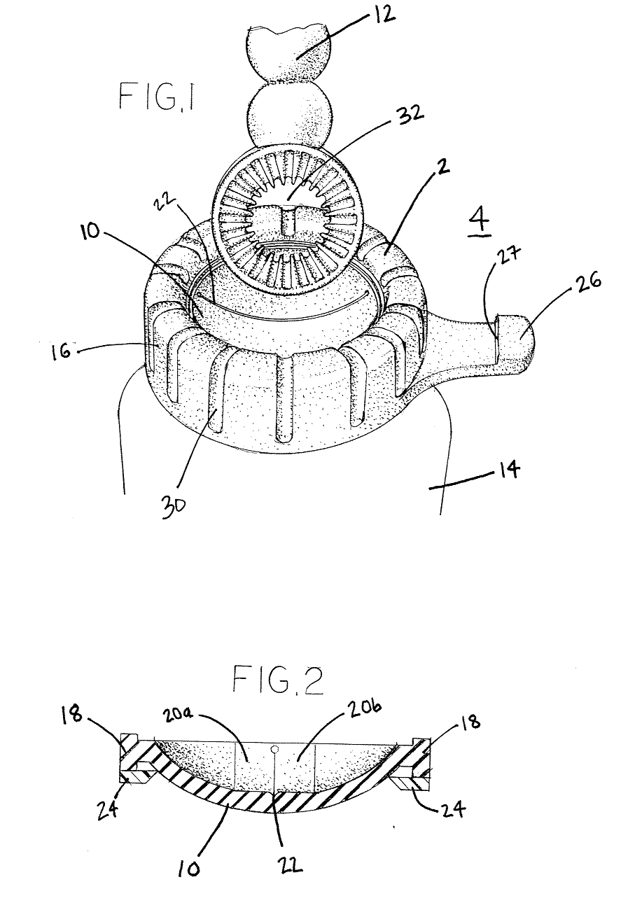

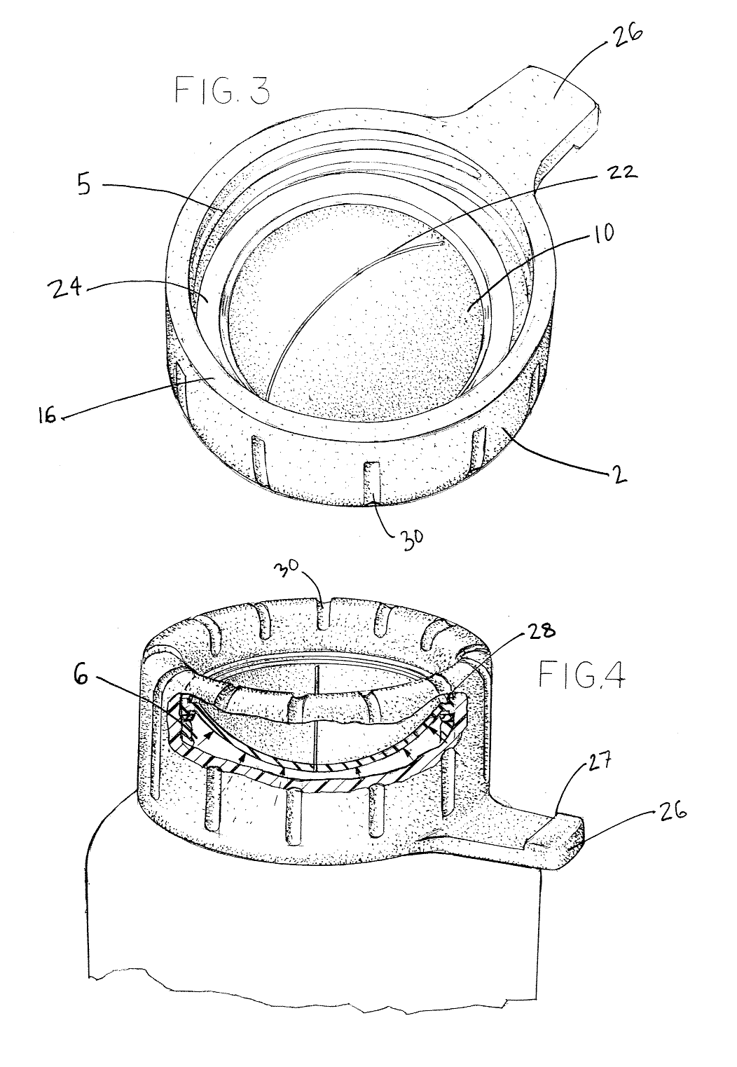

As shown in FIG. 1 a container assembly 4 is generally provided with a container 14, a lid assembly 2, and a fluid carrier member 12, which can be a bubble wand. The container 14 is adapted to contain and receive a fluid, such as a bubble solution, through an opening 6 depicted in FIG. 4. The opening 6 has threads, which mesh with threads 5, depicted in FIG. 3, located on the lid assembly 2. As depicted in FIG. 3, the lid assembly 2 consists of a seal member 10, which can be a wand-entry member, a lid rim 16, and a fastener ring 24.

Referring to FIGS. 1, 2, and 3, an exemplary embodiment of the seal member 10 is shown. A cross-sectional view of the seal member 10 is depicted in FIG. 2. The seal member 10 can be circular and partially spherical, and can have a generally concave cross-section. A slit 22 consisting of two sidewalls is formed in the center of the seal member 10. The slit 22 is elongated and divides the seal member 10 generally into equal halves.

As depicted in FIG. 2, the seal member 10 can have a circular edge rib 18. The circular edge rib 18 has a thickness which is greater than the thickness of a portion connecting the edge rib 18 to the circumference of the seal member 10.

The seal member 10 may be thickened in the area of the slit 22, to accommodate thinning elsewhere. Additionally, a first linear lip 20a and second linear lip 20b, which are parallel to the slit 22, may be thickened as well. The thickening in linear lips 20a and 20b are not shown in FIGS. 1 and 3, as the presence and absence of the thickening in the linear lips 20a and 20b provides alternate embodiments.

The seal member 10 can be formed of an elastic polymeric material in an injection molding process and can be formed of a thermoplastic elastomer. To achieve the desired softness of the elastic material paraffin oil may be added. For example, the seal may be formed of 60-70% thermoplastic elastomer and 30-40% paraffin oil. Preferably, the seal is formed of 65% thermoplastic elastomer and 35% paraffin oil. Once the seal member 10 is otherwise formed, as by being molded, the slit 22 can be cut by a sharp blade instrument, such as a guillotine.

FIG. 3 shows the lid assembly from below. The lid rim 16 can have threads 5 and is formed with an annular lip portion 28 as shown in FIGS. 1, 3, and 4. The outer circumference of the lid rim 16 can be formed with elongated grooves 30 to provide for a better grip on the lid rim 16 for assembling and disassembling the spill resistant container assembly 4. As shown in FIG. 3, a fastener ring 24 fits within the lid rim 16 to secure the seal member 10 into the lid rim 16. The fastener ring 24 underlies the seal member 10, and overlies the container rim (not shown).

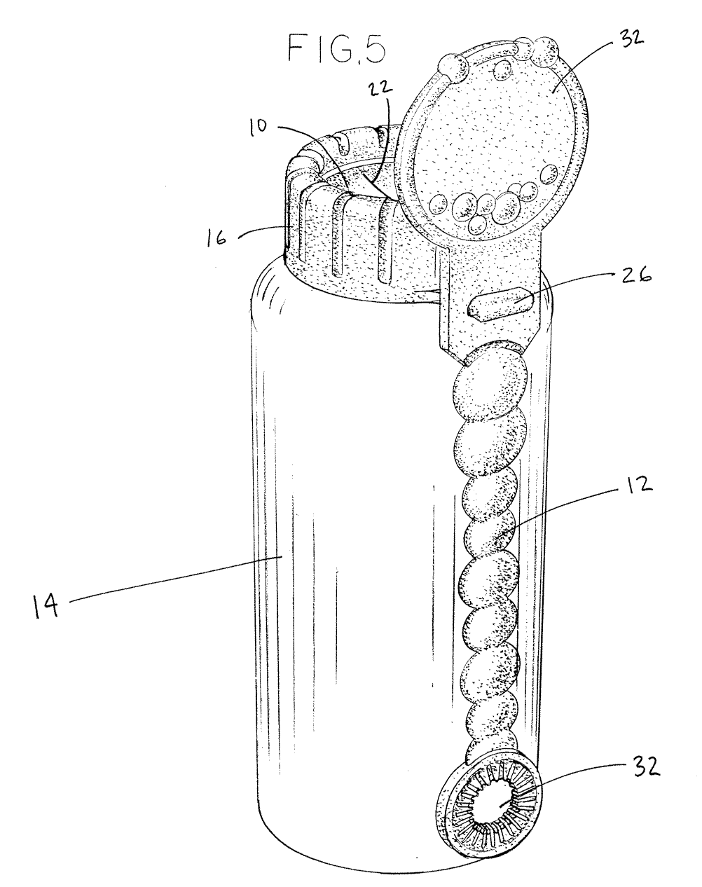

As depicted in FIGS. 1 and 3-5, the lid rim 16 can be provided with an outwardly extending flange 26 having a stepped portion 27, which engages an elongated notch 25 of the fluid carrier member 12 to store the fluid carrier member 12 when it is not in use. This additionally allows for better conservation of fluid because the user will be less inclined to leave the fluid carrier member 12 in the slit 22. When an end of the fluid carrier member 12 is located in the slit 22, more fluid can evaporate through the slot that is created by slit 22. Since the user will be more inclined to store the fluid carrier member 12 on the notch 25, less fluid will evaporate through the slit 22 in the ordinary use of the container assembly 4.

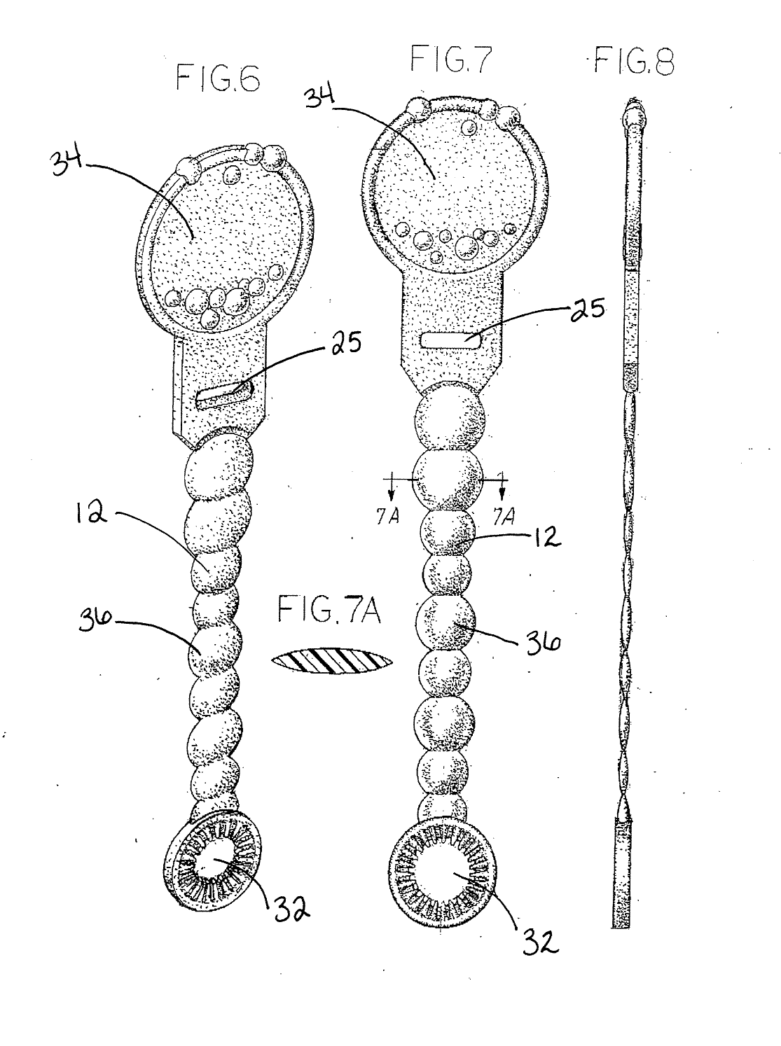

The fluid carrier member 12 is generally depicted in FIGS. 6-8. The fluid carrier member 12 can be formed with a first end having an opening 32 and a second end having a gripping portion 34 and a notch 25. The body 36 of the fluid carrier member 12 can taper to points located on its first side and its second side giving it a generally football-shaped cross-section as depicted in FIG. 7A, such that the body 36 can be easily wiped of excess fluid. Additionally, the body 36 of the fluid carrier member 12 can be formed of tapering discs 35, again such that the body 36 can be easily wiped of excess fluid. As mentioned above, the flange 26 of the lid rim 16 can be aligned with the notch 25 to store the fluid carrier member 12 when it is not in use.

In one exemplary embodiment, the seal member 10 is held in place to a top, threaded, circular rim of the container (not shown) by a circular, centrally open, and co-operatively threaded lid rim 16. To assemble the spill resistant container, the seal member 10 is placed into the lid rim 16 such that the annular lip portion 28 contacts the top surface of the circular edge rib 18 of the seal member 10. Next the fastener ring 24 is placed into the lid rim 16, such that the fastener ring 24 contacts the bottom surface of the circular edge rib 18. The lid assembly 2 is then tightened onto the opening of the container. As the lid assembly 2 is screwed in place atop the container, the seal member 10, which is a relatively flexible material, is held along its edge rib 18 between the more rigid lid rim 16 and the fastener ring 24. As depicted in FIG. 2, the fastener ring 24 may be thickened at the outer edge and thinned at the inner edge, to fit the top of the container rim and squeeze outward on the seal member 10 to best resist excess forces that otherwise might tend to dislodge the seal 10. The annular lip portion 28, the circular edge rib 18, and the fastener ring 24 provide a seal in the container assembly 4 around the periphery of the threaded lid rim 16.

As in FIG. 1, the top view is visible, with the fluid carrier member 12 suspended over the seal member 10 and oriented to go through the seal member 10 and into the fluid container 14, also shown. The user holds the gripping portion 34 of the fluid carrier member 12 to place the opening 32 of the fluid carrier member 12 into the slit 22. The slit 22 of the seal member 10 then flexes into a slot around the first end of the fluid carrier member to allow the opening 32 of the fluid carrier member 12 to enter into the fluid. The fluid then comes into contact with the opening 32 of the fluid carrier member 12. A minimal amount of bubble solution then fills the opening 32 of the fluid carrier member 12. The user then removes the fluid carrier member from the slit 22 to transport the opening 32 of the fluid carrier member 12 near the user's mouth. As the fluid carrier member 12 is removed from the slit 22, as discussed below, the seal member 10 wipes the fluid carrier member 12 of any excess fluid. The user then blows air through the opening 32 to blow bubbles.

The elasticity of the seal member 10 retains the slit 22 in a normally closed position to aid in preventing spills of the fluid in the container 14. If the container or associated toy is tipped or knocked over, the seal member 10 limits spilling of the fluid in a substantial variety of orientations. Preferably, if the seal member 10 and associated parts are well constructed, it will eliminate spills in a substantial variety of orientations. As depicted in FIG. 4, during tipping and knock-overs, the fluid pushes against the back convex side of the seal member 10 from within the container to put fluid pressure on the seal member 10. The fluid pressure acting on the curved, convex shape of the seal member 10 pushes the slit 22 closed and further prevents spills. Also, if the fluid carrier member 12 is present, the slot formed by the slit 22 receiving the fluid carrier member 12 is typically filled by the fluid carrier member, and the slit 22 forms a seal around the fluid carrier member 12, again limiting and preferably eliminating spills in a substantial variety of orientations.

As persons of ordinary skill will observe, variations from the exemplary embodiments may be made without departing from the letter or spirit of the disclosure. The seal member can be formed of different shapes without departing from the scope of the disclosure. Also the container can be fastened together by any known fastening methods. As an extreme example, poorly made seal members may allow some drippage or even spillage without departing from the disclosure. Additionally, the spill resistant container assembly has other applications. For example, the spill resistant container can be used as a paint container and the slit 22 in the seal member 10 can be adapted to receive a paint brush.

In sum, as to the exemplary embodiments, a seal member 10, such as a wand-entry member, co-operates with a container 14 and lid rim 16, and includes a convex/concave central portion with slit sidewalls, defining a slit 22. The slit 22 is smooth and has infinitesimal to zero space between the equally smooth sidewalls as the sidewalls are in a rest position and no fluid carrier member is present.

The elasticity and shape of the seal member 10 allows the slit sidewalls to contact each other in the absence of a fluid carrier member 12, and to separate or allow the fluid carrier member 12 to enter the slit 22 and to open into a slot, resiliently, for passage of the fluid carrier member through the seal member and into the container. The slit opens to be a slot just as wide as the fluid carrier member thickness when the sidewalls are separated, and the fluid carrier member 12 is passing through. As the fluid carrier member 12 is pulled from the container, the slit 22 is resiliently biased against the fluid carrier member 12 and the sidewalls of the slit touch and wipe the fluid carrier member. The wiping action has an additional advantage of reducing dripping of excess fluid from the fluid carrier member 12 when removed from the container 14. The downward, inward concave shape of the seal member 10 also has the advantage of collecting fluid not wiped and directing it through the slots into the bottle when opened by reinserting the fluid carrier member.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It is also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art. Various features are set forth in the following claims.

1. A spill resistant container assembly comprising:
a container adapted to contain a fluid, the container having an opening;
a fluid carrier member being capable of receiving and transporting the fluid; and
a partially spherical seal member extending across the opening so as to aid in limiting the fluid from leaking from the container in a substantial variety of orientations of the container, the seal member having an area defining a slit and having elasticity proximate to the slit, the area and the slit capable of permitting receipt and removal of a portion of the fluid carrier member.

2. The spill resistant container assembly of claim 1 further comprising a lid rim having a threaded portion, an annular lip portion, and a fastener ring; the seal member further comprising an annular edge rib, wherein the annular edge rib of the seal member is secured between the annular lip portion and the fastening ring.

3. The spill resistant container assembly of claim 2 wherein the container opening has a threaded portion and wherein the lid rim threadably engages the container opening.

4. The spill resistant container assembly of claim 1 wherein the seal member is generally elastic, and the elasticity of the seal member holds the slit in a generally closed position.

5. The spill resistant container assembly of claim 1 wherein when the fluid carrier member is placed in the slit of the seal, the elasticity of the seal member is capable of forming at least a partial seal around the fluid carrier member so as to aid in preventing the fluid in the container from flowing through the opening in the container in a variety of orientations of the container.

6. The spill resistant container assembly of claim 1 wherein the slit is elongated and extends generally across the opening, thereby defining portions of the seal member.

7. (canceled)

8. A spill resistant container assembly comprising:
a container adapted to contain a fluid, the container having an opening;
a fluid carrier member being capable of receiving and transporting the fluid; and
a seal member extending across the opening so as to aid in limiting the fluid from leaking from the container in a substantial variety of orientations of the container, the seal member having an area defining a slit and having elasticity proximate to the slit, the area and the slit capable of permitting receipt and removal of a portion of the fluid carrier member, wherein a first lip and a second lip abut each other to form the slit of the seal member and wherein the fluid carrier member has a shaft such that when the fluid carrier member is removed from the container, the first lip and the second lip of the seal member wipe the shaft of some fluid, wherein the first lip and the second lip have a first thickness and a portion of the seal member has a second thickness adjacent the first lip and the second lip; and wherein the first thickness is greater than the second thickness.

9. The spill resistant container assembly of claim 8 wherein the seal member is generally elastic and has a partially spherical shape, wherein the partially spherical shape and the elasticity of the seal member help in retaining the slit in a generally closed position.

10. A spill resistant bubble solution container assembly comprising:
a container adapted to contain a bubble solution, the container having an opening;
a wand member having a first end and a second end; the first end having an opening capable of receiving and transporting the bubble solution at one end thereof, and
a generally elastic and partially spherical seal member extending across the opening so as to aid in preventing the bubble solution from leaking from the container in a substantial variety of orientations of the container, the seal member having a slit capable of receiving the first end of the wand member and substantially closing on removal of the wand member.

11. The spill resistant bubble solution container assembly of claim 10 further comprising a lid rim having a threaded portion, an annular lip portion and a fastener ring, the seal member further comprising an annular edge rib, wherein the annular edge rib of the seal member is secured between the annular lip portion and the fastener ring.

12. The spill resistant bubble solution container assembly of claim 11 wherein the container opening has a threaded portion and wherein the lid rim threadably engages the threaded portion of the container opening.

13. (canceled)

14. The spill resistant bubble solution container assembly of claim 10 wherein the slit is elongated and extends generally across the opening to divide the seal member into substantially equal halves.

15. The spill resistant bubble solution container assembly of claim 10 wherein the seal member further comprises a first lip and a second lip, the first lip and the second lip having a thickness, the thickness being greater than a portion of the seal member adjacent the first lip and the second lip; wherein the first lip and the second lip abut each other to form the slit of the seal member; and wherein the wand member has a tapered shaft such that when the fluid carrier member is removed from the container, the first lip and the second lip of the seal member wipe the tapered shaft of excess fluid.

16. The spill resistant bubble solution container assembly of claim 10 wherein the elasticity and partially spherical shape of the seal member aid in retaining the slit in a closed position.

17. A method of providing a spill resistant container comprising:
providing a container adapted to contain a fluid, the container having an opening;
providing a generally elastic and partially spherical seal member extending across the opening so as to aid in preventing a fluid from leaking from the container in a substantial variety of orientations of the container, the seal member having a slit capable of receiving a fluid transfer member and an annular edge rib;
providing a lid rim having an annular lip portion;
providing a fastener ring; and
securing the annular edge rib of the seal member between the annular lip portion of the lid rim and the fastener ring.

18. The method of providing a spill resistant container of claim 17 further comprising providing the container opening with threads; providing the lid rim with threads; and fastening the lid rim to the container opening.

19. The method of providing a spill resistant container of claim 17 further comprising providing the seal member with enough elasticity such that the slit is held in a generally closed position.

20. A method of forming a seal member comprising:
forming a circular shaped seal member in an injection molding process, the seal member having a circular edge rib;
providing a thermoplastic elastomer for forming the seal; and
after removing the seal member from the injection mold forming an elongated slit in the seal member.

21. The method of forming a seal member of claim 20 wherein the step of forming the elongated slit is performed by one of tearing and cutting.

22. A seal member for a fluid container, comprising: a partially spherical and generally elastic structure, the structure defining a slit, wherein the slit is capable of receiving an end of a fluid carriers, and wherein the seal member is capable of extending across an opening in the container and aids in inhibiting fluid from leaking from the container in a substantial variety of orientations of the container.

23. The seal member of claim 22 having a body, wherein the slit is elongated and extends generally across the body of the seal member, the seal member further comprising: a first lip and a second lip, wherein the first lip and the second lip generally abut each other to form the slit; and an annular edge rib extending around the outer circumference of the body of the seal; and wherein the seal member is generally elastic and the elasticity of the seal member holds the slit in a generally closed position.

24. The seal member of claim 22 wherein when a fluid carrier member is placed in the slit of the seal, the slit opens wide enough to receive the fluid carrier member and the elasticity of the seal member is capable of forming at least a partial seal around the fluid carrier member.

25. The seal member of claim 24 wherein the seal member is formed of an elastomer, the first lip and the second lip of the seal member are adapted to wipe a fluid carrier member of excess fluid, and wherein the elasticity and the partially spherical shape of the seal member help in retaining the slit in a closed position.
